(19) United States
(12) Patent Application Publication
(10) Pub. No.: US 2013/0288103 A1
(43) Pub. Date: Oct. 31, 2013

(54) COMPOSITE POROUS FILM AND METHOD FOR MANUFACTURING SAME

(71) Applicants: Naoki Mizuno, Tochigi (JP); Michihiko Irie, Tochigi (JP); Yoshitaka Ayuzawa, Tochigi (JP); Masanori Nakamura, Tochigi (JP)

(72) Inventors: Naoki Mizuno, Tochigi (JP); Michihiko Irie, Tochigi (JP); Yoshitaka Ayuzawa, Tochigi (JP); Masanori Nakamura, Tochigi (JP)

(73) Assignee: Toray Battery Separator Film Co., Ltd., Nasushiobara (JP)

(21) Appl. No.: 13/882,759

(22) PCT Filed: Aug. 29, 2011
(86) PCT No.: PCT/JP2011/069411

§ 371 Date: Jul. 17, 2013

(30) Foreign Application Priority Data
Nov. 5, 2010 (JP) 2010-248033

(51) Int. Cl. H01M 2/16; H01M 2/14; H01M 2/18

(52) U.S. Cl. CPC H01M 2/16; H01M 2/18; H01M 2/145
USPC 429/145; 156/280; 156/230

(57) ABSTRACT

A composite porous membrane used as a separator for a battery includes a porous membrane A made of a polyolefin resin and a porous membrane B containing a heat-resistant resin laminated thereto, wherein the surface of the porous membrane B on the side that does not face the porous A has a three-dimensional network structure having nodes, and the peeling interface on the side of the porous membrane B formed when the porous membrane A and the porous membrane B are peeled off has a membrane morphology having pores with a pore size of 50 to 500 nm in an amount of at least 100 pores/10 μm².

### TECHNICAL FIELD

The present invention relates to a composite porous membrane comprising a porous membrane made of a polyolefin resin and a porous membrane containing a heat-resistant resin layer laminated thereto. The present invention particularly relates to a composite porous membrane useful as a separator for a separator for a large-sized lithium ion secondary battery, which composite porous membrane has excellent ion permeability and shows very little variation in air resistance.

### BACKGROUND ART

Porous membranes made of a thermoplastic resin have been widely used, for example, as a material for separation, selective permeation, and isolation of substances. Examples of the material include a battery separator used in a lithium ion secondary battery, nickel-hydrogen battery, nickel-cadmium battery, and polymer battery; a separator for an electric double layer capacitor; various filters such as a reverse osmosis filtration membrane, ultrafiltration membrane, and microfiltration membrane; moisture-permeable waterproof clothing; a medical material; and the like. In particular, polyethylene porous membranes have been suitably used as a separator for a lithium ion secondary battery, because they are not only characterized by having excellent electrical insulating properties, having ion permeability by electrolyte impregnation, and having excellent electrolyte resistance/oxidation resistance, but also have such a pore-blocking effect that excessive temperature rise is suppressed by blocking a current at a temperature of about 120 to 150° C. in abnormal temperature rise in a battery. However, when the temperature continues to rise for some reason even after pore blocking, membrane rupture can occur at a certain temperature due to decrease in viscosity of a molten polyethylene constituting the membrane and shrinkage of the membrane. In addition, when left at a constant high temperature, membrane rupture can occur after the lapse of a certain time due to decrease in viscosity of a molten polyethylene and shrinkage of the membrane. This phenomenon is not a phenomenon that occurs only when polyethylene is used, and also when other thermoplastic resins are used, this phenomenon cannot be avoided at or higher than the melting point of the resin constituting the porous membrane.

In particular, a separator for a lithium ion battery is highly responsible for battery properties, battery productivity, and battery safety, and required to have excellent mechanical properties, heat resistance, permeability, dimensional stability, pore-blocking property (shutdown property), melt rupture property (meltdown), and the like. Accordingly, various studies to improve heat resistance have been conducted until now.

Further, in recent years, lithium ion secondary batteries have been considered to be used widely in lawn mowers, grass cutters, small boats, and the like in addition to electric vehicles, hybrid vehicles, and power-assisted bicycles. Accordingly, batteries that are relatively large compared to those in small electronic devices such as conventional cellular phones and notebook computers have become necessary, and also for separators incorporated into a battery, wide ones, for example, those with a width of 100 mm or more have been demanded. However, a polyolefin porous membrane used for a porous membrane that serves as a substrate film generally has a thickness of 30 μm or less and has extremely low tensile strength and stiffness; thus, it has been difficult to ensure the planarity, and it has been difficult to laminate a heat-resistant resin uniformly. As a result, the variation in air resistance is extremely large, and it has been hard to obtain stable air resistance. In particular, when a polyolefin porous membrane has a thickness of 20 μm or less, this tendency manifests itself more clearly.

Patent Document 1 discloses a separator for a lithium ion secondary battery obtained by direct application of a polyamide-imide resin to a polyolefin porous membrane with a thickness of 25 μm to a membrane thickness of 1 μm and dipping in water at 25° C., followed by drying.

As in the case of Patent Document 1, when using the roll coating method, die coating method, bar coating method, blade coating method, and the like which are commonly used to apply a coating solution to a polyolefin porous membrane, the polyolefin porous membrane had a weak tensile strength and stiffness, which were likely to lead to membrane thickness unevenness of a heat-resistant resin layer and caused a large variation in air resistance. Further, the air resistance of the composite porous membrane was significantly higher than that of a polyolefin porous membrane that served as a substrate.

Patent Document 2 discloses an electrolyte-supported polymer membrane obtained by dipping of a nonwoven fabric with an average membrane thickness of 36 μm comprising aramid fibers in a dope containing a vinylidene fluoride copolymer which is a heat-resistant resin, and drying.

Patent Document 3 discloses a composite porous membrane obtained by dipping of a polypropylene porous membrane with a membrane thickness of 25.6 μm in a dope mainly composed of polyvinylidene fluoride which is a heat-resistant resin, followed by the process of a coagulation bath, washing with water, and drying.

When a nonwoven fabric comprising aramid fibers is dipped in a heat-resistant resin solution as in Patent Document 2, a heat-resistant porous layer is formed inside and on both surfaces of the nonwoven fabric, and accordingly most of the continuous pores inside the nonwoven fabric are likely to be blocked; consequently, significant increase in air resistance cannot be avoided. In addition, the most important blocking function that determines safety of a separator cannot be obtained.

Also in Patent Document 3, a heat-resistant porous layer is similarly formed inside and both surfaces of a polypropylene porous membrane, and as in Patent Document 2, significant increase in air resistance cannot be avoided; besides it is difficult to obtain a pore-blocking function.

Patent Document 4 discloses a composite porous membrane obtained in such a manner that a propylene film is coated with a polyamide-imide resin solution and passed through an atmosphere at 25° C. and 80% RH over 30 seconds to obtain a semi-gel like porous membrane; then a polyethylene porous film with a thickness of 20 μm or 10 μm is laminated onto the semi-gel like porous membrane, dipped in an aqueous solution containing N-methyl-2-pyrrolidone (NMP), and then washed with water and dried. However, the variation in air resistance of the composite porous membrane in Patent Document 4 was far from satisfactory.

As described above, for a composite porous membrane comprising a polyolefin or other porous membrane that serves as a substrate and a heat-resistant resin layer laminated thereto, those which satisfy both the rising range of air resistance and variation in air resistance have never existed before.

### PRIOR ART DOCUMENTS

### Patent Documents

Patent Document 1: JP 2005-281668 A
Patent Document 2: JP 2001-266942 A
Patent Document 3: JP 2003-171495 A
Patent Document 4: JP 2007-125821 A

### SUMMARY OF THE INVENTION

### Problems to be Solved by the Invention

The present invention has been developed in view of such circumstances of the prior art, and an object of the present invention is to provide a separator for a battery that shows very little variation in air resistance and does not show a significant increase in air resistance even in the case of a relatively wide separator for a battery which is demanded when batteries become larger in size.

### Means for Solving the Problems

The present invention has a constitution from (1) to (9) below.

(1) A composite porous membrane used as a separator for a battery, comprising a porous membrane A made of a polyolefin resin and a porous membrane B containing a heat-resistant resin laminated thereto, wherein the surface of the porous membrane B on the side that does not face the porous A has a three-dimensional network structure having nodes, and the peeling interface on the side of the porous membrane B formed when the porous membrane A and the porous membrane B are peeled off has a membrane morphology having pores with a pore size of 50 to 500 nm in an amount of at least 100 pores/10 μm².
(2) The composite porous membrane according to (1), wherein the following equation is satisfied:

10≦Y−X≦110

wherein, X is an air resistance (sec/100 cc Air) of the porous membrane A, and Y is an air resistance (sec/100 cc Air) of the whole composite porous membrane.

(3) The composite porous membrane according to (1) or (2), wherein the composite porous membrane has a width of 100 mm or more.
(4) The composite porous membrane according to any one of (1) to (3), wherein the composite porous membrane has an air resistance of 50 to 800 sec/100 cc Air.
(5) The composite porous membrane according to any one of (1) to (4), wherein the heat-resistant resin is a polyamide-imide resin, polyimide resin, or polyamide resin.
(6) A method of producing the composite porous membrane according to any one of (1) to (5) comprising the Steps (i) and (ii) below:

Step (i): A step of coating a heat-resistant resin solution having a solids concentration of the heat-resistant resin of 1% by weight to 6% by weight onto a substrate film, and then passing the substrate film through a low humidity zone at an absolute humidity of less than 6 g/m³ to form a heat-resistant resin membrane on the substrate film; and

Step (ii): A step of laminating the heat-resistant resin membrane formed in Step (i) and the porous membrane A made of a polyolefin resin, and then converting the heat-resistant resin membrane into a porous membrane B by dipping in a coagulation bath, followed by washing and drying, thereby obtaining a composite porous membrane.

(7) The method of producing a composite porous membrane according to (6), wherein the substrate film is peeled off after obtaining a composite porous membrane in Step (ii).
(8) The method of producing a composite porous membrane according to (6) or (7), wherein the substrate film is a polyester film or polyolefin film with a thickness of 25 to 100 μm.
(9) The method of producing a composite porous membrane according to any one of (6) to (8), wherein, in Step (i), the time of passage through the low humidity zone is 3 seconds to 30 seconds.

### Effects of the Invention

The composite porous membrane of the present invention, even when it is one with a width of 100 mm or more, shows very little variation in air resistance and a reduced increase in air resistance and thus can be very suitably used as a separator for a large-sized battery.

### BRIEF DESCRIPTION OF THE DRAWINGS

FIG. 1 is an SEM photograph of the surface of the porous membrane B of the composite porous membrane of Example 1 on the side that does not face the porous membrane A;

FIG. 2 is an SEM photograph of the surface of the porous membrane B of the composite porous membrane of Example 1 on the side of the interface with the porous membrane A;

FIG. 3 is an SEM photograph of the surface of the porous membrane B of the composite porous membrane of Comparative Example 1 on the side that does not face the porous membrane A;

FIG. 4 is an SEM photograph of the surface of the porous membrane B of the composite porous membrane of Comparative Example 1 on the side of the interface with the porous membrane A; and

FIG. 5 is an SEM photograph of the surface of the porous membrane B of the composite porous membrane of Comparative Example 3 on the side of the interface with the porous membrane A.

### BEST MODE FOR CARRYING OUT THE INVENTION

The composite porous membrane of the present invention comprises a porous membrane A made of a polyolefin resin and a porous membrane B containing a heat-resistant resin laminated thereto, the composite porous membrane achieving a hitherto unachieved uniform air resistance with little variation also as a relatively wide separator with a width of 100 mm or more using a specific coating solution and an advanced processing technique mentioned below without causing a significant increase in air resistance due to lamination.

The variation in air resistance of a composite porous membrane in the present invention is determined by measuring an air resistance at at least 50 points in total at intervals of 2 cm to 10 cm in the width direction and the machine direction of a separator and dividing the difference (T (R)) between the maximum value and the minimum value by the average value (T(ave)). For the variation in air resistance of the composite porous membrane, there is no practical problem if a variation range T (R) based on the average air resistance (T(ave)) is not more than 30%.

“Significant increase in air resistance” herein means that the difference between an air resistance of the porous membrane A that serves as a substrate (X) and an air resistance of the composite porous membrane (Y)(Y−X) is more than 110 sec/100 cc Air.

The composite porous membrane of the present invention is characterized in that, when observed under a scanning electron microscope, the surface of the porous membrane B on the side that does not face the porous membrane A has a three-dimensional network structure having nodes, and the peeling interface on the side of the porous membrane B formed when the porous membrane A and the porous membrane B are peeled off has a membrane morphology having pores with a pore size of 50 to 500 nm in an amount of at least 100 pores/10 μm².

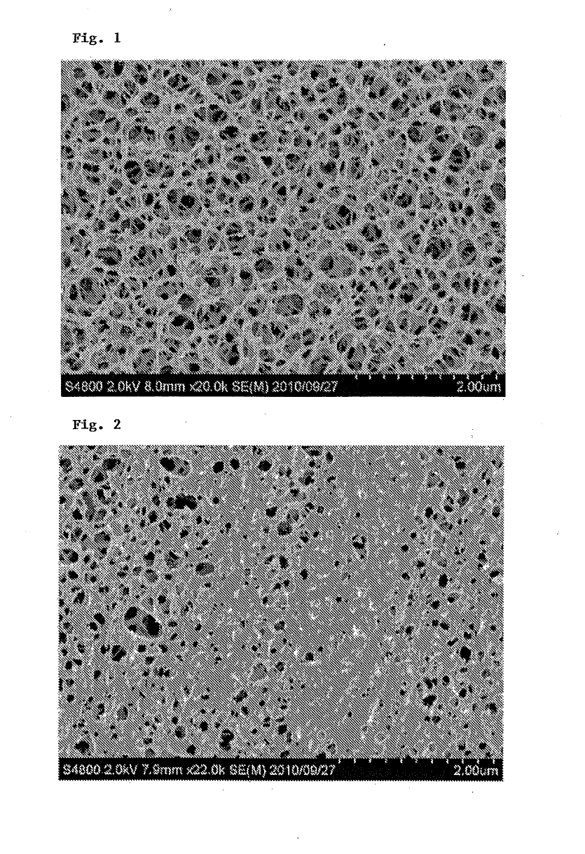

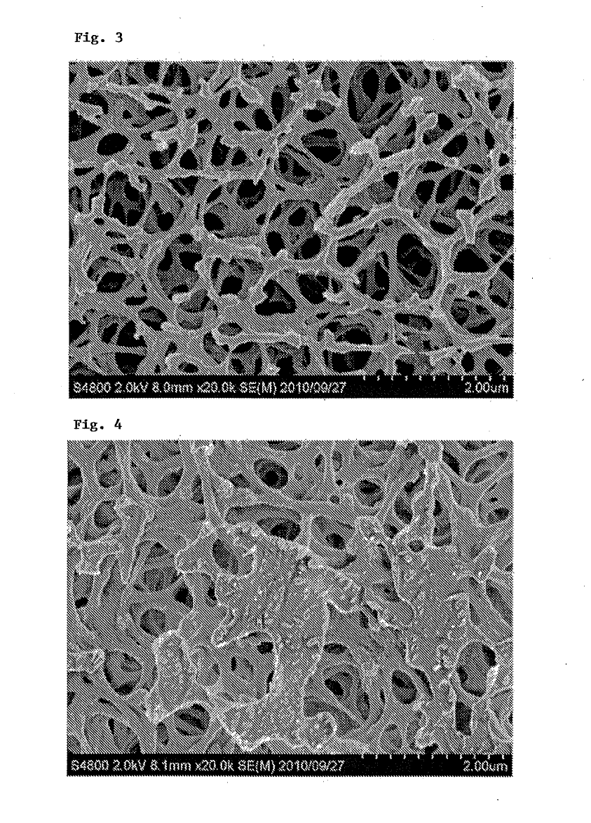

“Three-dimensional network structure having nodes” herein refers to a state where short fibers with a length, for example, of about 0.1 to 3 μm is forming a stereoscopic network structure through nodes (see FIG. 1). A membrane in which pores exist at the peeling interface on the side of the porous membrane B, unlike the stereoscopic network structure mentioned above, refers to a state of having a layer with pores between the porous membrane A and the porous membrane B (see FIG. 2).

A three-dimensional network structure having nodes and a membrane having pores can be readily distinguished by observation under a scanning electron microscope (SEM) at 5000 to 30000 magnifcation. In the composite porous membrane of the present invention, the membrane of the peeling interface on the side of the porous membrane B described above has pores with a pore size of 50 to 500 nm in an amount of at least 100 pores/10 μm², more preferably at least 200 pores/10 μm², and most preferably at least 300 pores/10 μm². Although the upper limit of the number of pores is not particularly restricted, when it is more than 2000 pores/10 μm², the proportion of a resin membrane portion in the whole porous membrane having pores decreases, and therefore adhesion of the porous membrane B can be reduced, which is not preferred.

When a heat-resistant resin layer in a semi-gel state is laminated to a polyolefin resin porous membrane and then dipped in a coagulation bath to make the heat-resistant resin membrane porous as in Patent Document 4, in the heat-resistant resin layer (corresponding to the porous membrane B in the present invention), both the surface that does not face the porous membrane A and the interface peeled off from the porous membrane A will generally have a three-dimensional network structure having nodes. On the other hand, in the composite porous membrane of the present invention, although the surface that does not face the porous membrane A has a three-dimensional network structure having nodes, the peeling interface of the porous membrane B peeled off from the porous membrane A is in a state of a membrane having at least a particular number of pores with a particular pore size, the structure being distinct from the three-dimensional network structure having nodes in the peeling interface of the porous membrane B peeled off from the porous membrane A in Patent Document 4 described above. The composite porous membrane of the present invention, being in such a morphology, can achieve a reduced rising range of air resistance and besides extremely uniform air resistance in the width direction and the machine direction, and can be suitably used for a wide large-sized battery separator.

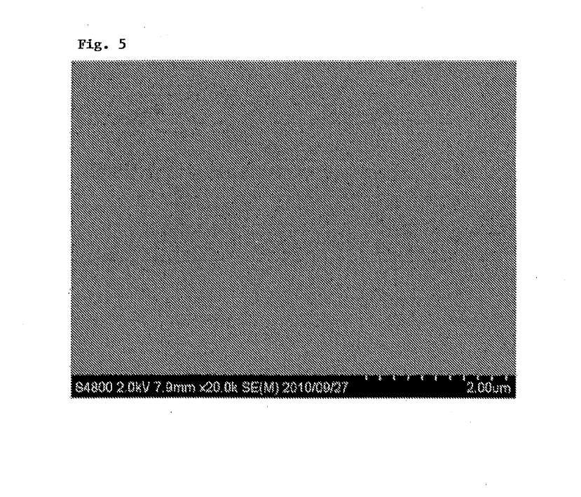

When the morphology of a peeling surface of the porous membrane B is a three-dimensional network structure as in the case of the composite porous membrane in Patent Document 4, plate resin blocks with such a size that a circle with a diameter of 0.3 to 2.0 μm is included can occur at some parts (see FIG. 4), which plate resin blocks close pores of the porous membrane A just like lidding them, increasing the air resistance. These plate resin blocks cause large variation in air resistance because their occurrence frequency varies greatly between the width direction and the machine direction. There are some parts where the plate resin blocks described above are not formed, but this case is not practical because of extremely low adhesion to the porous membrane A. On the other hand, the peeling interface of the porous membrane B peeled off from the porous membrane A in the present invention has a small rising range of air resistance because it is in a state of a membrane having a particular number of pores with a particular pore size, and, besides, has an extremely uniform air resistance because the plate resin blocks as described above do not exist.

First, the porous membrane A used in the present invention will be described.

The resin that constitutes the porous membrane A is a polyolefin resin and may be a single substance, a mixture of two or more different polyolefin resins, for example, a mixture of polyethylene and polypropylene, or a copolymer of different olefins. In particular, polyethylene and polypropylene are preferred. This is because polyethylene and polypropylene has such a pore-blocking effect that excessive temperature rise is suppressed by blocking a current in abnormal temperature rise of a battery in addition to basic properties such as electrical insulating properties and ion permeability.

The mass average molecular weight (Mw) of the polyolefin resin is not particularly restricted and generally 1×10⁴ to 1×10⁷, preferably 1×10⁴ to 15×10⁶, and more preferably 1×10⁵ to 5×10⁶.

The polyolefin resin preferably comprises polyethylene. Examples of polyethylenes include ultra-high molecular weight polyethylene, high-density polyethylene, medium-density polyethylene, low-density polyethylene, and the like. Further, examples of polymerization catalysts include, but are not limited to, Ziegler-Natta catalysts, Phillips catalyst, metallocene catalysts, and the like. These polyethylenes may be not only a homopolymer of ethylene but also a copolymer containing a small amount of other α-olefins. Examples of suitable α-olefins other than ethylene include propylene, 1-butene, 1-pentene, 1-hexene, 4-methyl-1-pentene, 1-octene, (meth) acrylic acid, esters of (meth) acrylic acid, styrene, and the like.

The polyethylene may be a single substance but preferably is a mixture of two or more polyethylenes. As the polyethylene mixture, a mixture of two or more ultra-high molecular weight polyethylenes with different Mws, or a mixture of high-density polyethylenes, medium-density polyethylenes, and low-density polyethylenes with different Mws may be used, or a mixture of two or more polyethylenes selected from the group consisting of ultra-high molecular weight polyethylene, high-density polyethylene, medium-density polyethylene, and low-density polyethylene may be used.

In particular, as the polyethylene mixture, a mixture of ultra-high molecular weight polyethylene with a Mw of not less than 5×10⁵ and polyethylene with a Mw of not less than 1×10⁴ and less than 5×10⁵ is preferred. The Mw of the ultra-high molecular weight polyethylene is preferably 5×10⁵ to 1×10⁷, more preferably 1×10⁶ to 15×10⁶, and particularly preferably 1×10⁶ to 5×10⁶. As the polyethylene with a Mw of not less than 1×10⁴ and less than 5×10⁵, any of high-density polyethylene, medium-density polyethylene, and low-density polyethylene can be used, and in particular, it is preferable to use high-density polyethylene. As the polyethylene with a Mw of not less than 1×10⁴ and less than 5×10⁵, two or more polyethylenes with different Mws may be used, or two or more polyethylenes with different densities may be used. When the upper limit of the Mw of the polyethylene mixture is not more than 15×10⁶, melt extrusion can be readily carried out. The content of ultra-high molecular weight polyethylene in the polyethylene mixture is preferably 1% by weight or more and preferably 10 to 80% by weight.

The ratio of the Mw to the number average molecular weight (Mn) of the polyolefin resin, molecular weight distribution (Mw/Mn), is not particularly restricted, and is preferably in the range of 5 to 300 and more preferably 10 to 100. When Mw/Mn is less than 5, it is difficult to extrude a solution of the polyolefin because of too much high-molecular-weight components, and when Mw/Mn is more than 300, the resulting microporous membrane will have low strength because of too much low-molecular-weight components. Mw/Mn is used as an index of molecular weight distribution; namely, in the case of a polyolefin composed of a single substance, the larger this value, the wider the molecular weight distribution. The Mw/Mn of a polyolefin composed of a single substance can be adjusted as appropriate by means of multistage polymerization of the polyolefin. The Mw/Mn of a mixture of polyolefins can be adjusted as appropriate by adjusting the molecular weight and mixing ratio of each component.

Phase structure of the porous membrane A varies depending on the production method. As long as the various features described above are satisfied, phase structure for the intended purpose can be provided unrestrictedly depending on the production method. Examples of the method of producing a porous membrane include the foaming process, phase separation method, dissolution and recrystallization method, stretching pore-forming process, powder sintering process, and the like, among which the phase separation method is preferred in terms of uniform micropores and cost.

Examples of the production method according to the phase separation method include a method in which a porous membrane is obtained, for example, by melt blending polyolefin with a solvent for film formation, extruding the resulting molten mixture from a die, cooling the extrudate to form a gel-like molding, stretching the obtained gel-like molding in at least one axial direction, and removing the solvent for film formation, and the like.

The porous membrane A may be a monolayer membrane or a multi-layer membrane composed of two layers or more (e.g., composed of three layers of polypropylene/polyethylene/polypropylene or composed of three layers of polyethylene/polypropylene/polyethylene). For a method of producing a multi-layer membrane composed of two layers or more, the porous membrane A can be produced, for example, by either the method in which each of the polyolefins constituting A layer and B layer is melt blended with a solvent for film formation; the resulting molten mixtures are fed from each extruder to one die; and gel sheets constituting each component are integrated and co-extruded or the method in which gel sheets constituting each layer are laminated and heat-fused. The co-extrusion method is more preferred, because a high interlayer adhesive strength is easily obtained; high permeability is easily maintained because continuous pores are easily formed between layers; and the productivity is excellent.

The porous membrane A needs to have a function of blocking pores in the case of abnormal charge and discharge reaction. Accordingly, the melting point (softening point) of the constituent resin is preferably 70 to 150° C., more preferably 80 to 140° C., and most preferably 100 to 130° C. When it is less than 70° C., the pore-blocking function can be activated in normal use to make a battery inoperable. When it is more than 150° C., the pore-blocking function will be activated after an abnormal reaction has proceeded sufficiently, and therefore there is a concern that safety cannot be ensured.

The membrane thickness of the porous membrane A is preferably not less than 5 μm and less than 50 μm. The upper limit of the membrane thickness is more preferably 40 μm and most preferably 30 μm. The lower limit of the membrane thickness is more preferably 10 μm and most preferably 15 μm. When it is thinner than 5 μm, the membrane strength and pore-blocking function of practical use sometimes cannot be provided, and when it is not less than 50 μm, the electrode area per unit volume of a battery case is significantly restricted, which can be unsuitable for the increase in the capacity of a battery which is expected to progress in the future.

The upper limit of air resistance (JIS-P8117) of the porous membrane A is preferably 500 sec/100 cc Air, more preferably 400 sec/100 cc Air, and most preferably 300 sec/100 cc Air. The lower limit of air resistance is preferably 50 sec/100 cc Air, more preferably 70 sec/100 cc Air, and most preferably 100 sec/100 cc Air.

The variation in air resistance of the porous membrane A is preferably 10% or less, more preferably 5% or less, and still more preferably 3% or less. The variation in air resistance of the porous membrane A can be determined by the same method as used for the variation in air resistance of the composite porous membrane mentioned above.

The upper limit of the porosity of the porous membrane A is preferably 70%, more preferably 60%, and most preferably 55%. The lower limit of the porosity is preferably 30%, more preferably 35%, and most preferably 40%. When the air resistance is higher than 500 sec/100 cc Air or when the porosity is lower than 30%, sufficient charge and discharge properties, particularly, ion permeability (charge and discharge operating voltage) of a battery and the lifetime of a battery (closely related to the amount of electrolytic solution retained) are not sufficient, and when these limits are exceeded, it is likely that functions of a battery cannot be fully exerted. On the other hand, when the air resistance is lower than 50 sec/100 cc Air or when the porosity is higher than 70%, sufficient mechanical strength and insulation properties cannot be obtained, and it is highly likely that a short circuit occurs during charge and discharge.

The average pore size of the porous membrane A is preferably 0.01 to 1.0 μm, more preferably 0.05 to 0.5 μm, and most preferably 0.1 to 0.3 μm because it has a great influence on pore-blocking speed. When the average pore size is smaller than 0.01 μm, the anchoring effect of a heat-resistant resin is not readily obtained; thus sufficient adhesion of the heat-resistant resin sometimes cannot be obtained, and besides it is highly likely that the air resistance significantly deteriorates in complexation. When the average pore size is larger than 1.0 μm, phenomena can occur, such as slow response of a pore-blocking phenomenon to temperature, shift of a pore-blocking temperature depending on the temperature rise rate to the higher temperature side, and the like. Further, for the surface condition of the porous membrane A, when the surface roughness (arithmetic average roughness) is 0.01 to 0.5 μm, adhesion to the porous membrane B tends to be stronger. When the surface roughness is lower than 0.01 μm, an adhesion-improving effect is not observed, and when it is higher than 0.5 μm, decrease in mechanical strength of the porous membrane A or transcription of irregularities to the surface of the porous membrane B can occur.

The porous membrane B used in the present invention will now be described.

The porous membrane B serves to support/reinforce the porous membrane A with its heat resistance. Thus, the glass transition temperature of the constituent resin is preferably 150° C. or higher, more preferably 180° C. or higher, and most preferably 210° C. or higher, and the upper limit is not particularly limited. When the glass transition temperature is higher than a decomposition temperature, it is preferred that the decomposition temperature be in the range described above. When the glass transition temperature is lower than 150° C., a sufficient heat-resistant membrane rupture temperature cannot be obtained, and there is a concern that high safety cannot be ensured.

The heat-resistant resin constituting the porous membrane B is not particularly limited as long as it has heat resistance, and examples thereof include a resin mainly composed of polyamide-imide, polyimide, or polyamide; a resin mainly composed of polyamide-imide is preferred. These resins may be used alone or in combination with other materials.

The case where a polyamide-imide resin is used as a heat-resistant resin will now be described.

In general, a polyamide-imide resin is synthesized by a common method such as the acid chloride method using trimellitic acid chloride and diamine or the diisocyanate method using trimellitic acid anhydride and diisocyanate, and the diisocyanate method is preferred in terms of production cost.

Examples of the acid component used in the synthesis of a polyamide-imide resin include trimellitic acid anhydride (chloride), a portion of which can be replaced with other polybasic acid or anhydride thereof. Examples thereof include tetracarboxylic acids such as pyromellitic acid, biphenyltetracarboxylic acid, biphenylsulfonetetracarboxylic acid, benzophenonetetracarboxylic acid, biphenyl ether tetracarboxylic acid, ethylene glycol bistrimellitate, and propylene glycol bistrimellitate, and anhydrides thereof; aliphatic dicarboxylic acids such as oxalic acid, adipic acid, malonic acid, sebacic acid, azelaic acid, dodecane dicarboxylic acid, dicarboxypolybutadiene, dicarboxypoly(acrylonitrile-butadiene), and dicarboxypoly(styrene-butadiene); alicyclic dicarboxylic acids such as 1,4-cyclohexanedicarboxylic acid, 1,3-cyclohexanedicarboxylic acid, 4,4′-dicyclohexylmethanedicarboxylic acid, and dimer acid; and aromatic dicarboxylic acids such as terephthalic acid, isophthalic acid, diphenylsulfonedicarboxylic acid, diphenyl ether dicarboxylic acid, and naphthalenedicarboxylic acid. Among them, 1,3-cyclohexanedicarboxylic acid and 1,4-cyclohexanedicarboxylic acid are preferred in terms of electrolyte resistance; dimer acid, and dicarboxypolybutadiene, dicarboxypoly(acrylonitrilebutadiene), and dicarboxypoly(styrene-butadiene) with a molecular weight of 1000 or more are preferred in terms of shutdown property.

Also, a portion of a trimellitic acid compound can be replaced with a glycol to introduce a urethane group into a molecule. Examples of glycols include alkylene glycols such as ethylene glycol, propylene glycol, tetramethylene glycol, neopentyl glycol, and hexanediol; polyalkylene glycols such as polyethylene glycol, polypropylene glycol, and polytetramethylene glycol; polyesters with terminal hydroxyl groups synthesized from one or more of the dicarboxylic acids described above and one or more of the glycols described above; and the like, among which polyethylene glycol and polyesters with terminal hydroxyl groups are preferred in terms of a shutdown effect. The number average molecular weight of them is preferably 500 or more and more preferably 1000 or more. The upper limit is not particularly limited and preferably less than 8000.

When a portion of the acid component is replaced with at least one from the group consisting of dimer acid, polyalkylene ether, polyester, and butadiene rubber containing any one of a carboxyl group, a hydroxyl group, and an amino group at its terminal, it is preferable to replace 1 to 60 mol % of the acid component.

Examples of the diamine (diisocyanate) component used in the synthesis of a polyamide-imide resin include aliphatic diamines such as ethylenediamine, propylenediamine, and hexamethylenediamine, and diisocyanates thereof; alicyclic diamines such as 1,4-cyclohexanediamine, 1,3-cyclohexanediamine, and dicyclohexylmethanediamine, and diisocyanates thereof; aromatic diamines such as o-tolidine, tolylenediamine, m-phenylenediamine, p-phenylenediamine, 4,4′-diaminodiphenylmethane, 4,4′-diaminodiphenyl ether, 4,4′-diaminodiphenylsulfone, benzidine, xylylenediamine, and naphthalenediamine, and diisocyanates thereof; and the like, among which dicyclohexylmethanediamine and a diisocyanate thereof are most preferred in terms of reactivity, cost, and electrolyte resistance, and 4,4′-diaminodiphenylmethane, naphthalenediamine, and diisocyanates thereof are preferred. In particular, o-tolidine diisocyanate (TODI), 2,4-tolylene diisocyanate (TDI), and a blend thereof are preferred. In order particularly to improve adhesion of the porous membrane B, o-tolidine diisocyanate (TODI) which has high stiffness preferably accounts for 50 mol % or more, more preferably 60 mol % or more, and still more preferably 70 mol % or more of total isocyanates.

A polyamide-imide resin can be readily prepared by stirring in a polar solvent such as N,N′-dimethylformamide, N,N′-dimethylacetamide, N-methyl-2-pyrrolidone, or γ-butyrolactone with heating at 60 to 200° C. In this case, an amine such as triethylamine or diethylenetriamine; an alkali metal salt such as sodium fluoride, potassium fluoride, cesium fluoride, or sodium methoxide; or the like can also be used as a catalyst as required.

When a polyamide-imide resin is used, the inherent viscosity is preferably not less than 0.5 dl/g. When the inherent viscosity is less than 0.5 dl/g, sufficient meltdown property sometimes cannot be obtained because of a reduced melt temperature. In addition, the porous membrane becomes fragile because of the low molecular weight, and the anchoring effect decreases, which can reduce adhesion. On the other hand, the upper limit of the inherent viscosity is preferably less than 2.0 dl/g in view of processability and solvent solubility.

The porous membrane B is obtained by coating to a given substrate film a heat-resistant resin solution (varnish) obtained by dissolution in a solvent that is able to dissolve a heat-resistant resin and miscible with water, causing phase separation between the heat-resistant resin and the solvent miscible with water under humidified conditions, and further coagulating the heat-resistant resin by injection into a water bath (coagulation bath).

Examples of solvents that can be used to dissolve the heat-resistant resin include N,N-dimethylacetamide (DMAc), N-methyl-2-pyrrolidone (NMP), hexamethylphosphoric triamide (HMPA), N,N-dimethylformamide (DMF), dimethyl sulfoxide (DMSO), γ-butyrolactone, chloroform, tetrachloroethane, dichloroethane, 3-chloronaphthalene, parachlorophenol, tetralin, acetone, acetonitrile, and the like, and the solvent can be arbitrarily selected depending on the solubility of resins.

Although the solids concentration of the heat-resistant resin in the varnish is not particularly restricted as long as the varnish can be applied uniformly, it is preferably 1% by weight to 6% by weight and more preferably 2% by weight to 5% by weight. When the solids concentration is less than 1% by weight, coating can be difficult because of an increased amount of WET coating. When it is more than 6% by weight, it is not preferred because the amount of heat-resistant resin that permeates into pores of the porous membrane A increases, resulting in an increased rising range of air resistance.

Further, to reduce the heat shrinkage rate of the porous membrane B and provide slip characteristics, inorganic particles or heat-resistant polymeric particles may be added to the varnish. When the particles are added, the upper limit of the addition amount is preferably 95% by weight. When the addition amount is more than 95% by weight, the percentage of the heat-resistant resin in the total volume of the porous membrane B is small, and sufficient adhesion of the heat-resistant resin sometimes cannot be obtained.

Examples of the inorganic particles include calcium carbonate, calcium phosphate, amorphous silica, crystalline glass filler, kaolin, talc, titanium dioxide, alumina, silica-alumina composite oxide particles, barium sulfate, calcium fluoride, lithium fluoride, zeolite, molybdenum sulfide, mica, and the like. Examples of the heat-resistant polymeric particles include crosslinked polystyrene particles, crosslinked acrylic resin particles, crosslinked methyl methacrylate particles, benzoguanamine/formaldehyde condensate particles, melamine/formaldehyde condensate particles, polytetrafluoroethylene particles, and the like.

For reducing the process contamination in a battery processing process due to falling off of the particles, a method in which the heat-resistant resin contains substantially no particles is also preferred. Containing substantially no particles in the heat-resistant resin means that, for example, in the case of inorganic particles, the content of inorganic elements when quantitatively determined by X-ray fluorescence analysis is 50 ppm or less, preferably 10 ppm or less, and most preferably below the detection limit. This is because, even if particles are not added positively into a substrate film, the film can be contaminated by contaminants derived from foreign substances, raw resin, or peeling off of the dirt attached to a line or apparatus in the process for producing the film.

In the present invention, the moisture percentage of the varnish is preferably 0.5% by weight or less and more preferably 0.3% by weight or less. When it is more than 0.5% by weight, the heat-resistant resin component is likely to coagulate during storage of the varnish or immediately after application, and consequently plate resin blocks are likely to generate at the interface between the porous membrane A and the porous membrane B, resulting in increased variation in air resistance as well as an increased rising range of air resistance.

The moisture percentage of the varnish 0.5% by weight or less can be achieved by reducing the moisture percentage of the heat-resistant resin, solvent, and, further, additives such as inorganic particles to 0.5% by weight or less, and it is preferable to use raw materials of each after being dewatered or dried. Further, it is desired that the varnish be stored during the time from preparation to coating such that it is exposed to the outside air as little as possible. The moisture percentage of the varnish can be measured using the Karl Fischer method.

When a heat-resistant resin is made porous by phase separation, a phase separation aid is generally used in order to accelerate the processing speed, and in the present invention, the amount of the phase separation aid used is preferably less than 12% by mass, more preferably 6% by mass or less, and still more preferably 5% by mass or less, based on the solvent components of the varnish. By adding a phase separation aid in such an amount, the effect of reducing the difference in air resistance between the porous membrane A and the composite porous membrane can be obtained, but when the amount is not less than 12% by mass, variation in air resistance can increase.

The membrane thickness of the porous membrane B is preferably 1 to 5 μm, more preferably 1 to 4 μm, and most preferably 1 to 3 μm. When the membrane thickness is thinner than 1 μm, there is a concern that the membrane rupture strength and insulation properties cannot be ensured when the porous membrane A has molten/shrunk at or higher than the melting point. When it is thicker than 5 μm, the percentage of the porous membrane A is small, and an abnormal reaction sometimes cannot be prevented because a sufficient pore-blocking function cannot be obtained. Further, curling tends to increase, and handling in a post-process can be difficult. The variation in membrane thickness of the porous membrane B is preferably less than 30% and more preferably less than 15%. When it is not less than 30%, variation in air resistance increases. The variation in membrane thickness of the porous membrane B can be determined by the same method as used for the variation in air resistance of the composite porous membrane mentioned above.

The porosity of the porous membrane B is preferably 30 to 90% and more preferably 40 to 70%. When the porosity is less than 30%, the electrical resistance of the membrane increases, and it becomes difficult to apply a high current. On the other hand, when the porosity is more than 90%, the membrane strength tends to weaken. When an air resistance of the porous membrane B is measured by a method in accordance with JIS-P8117, the value obtained is preferably 1 to 2000 sec/100 cc Air, more preferably 50 to 1500 sec/100 cc Air, and still more preferably 100 to 600 sec/100 cc Air. When the air resistance is less than 1 sec/100 cc Air cc, membrane strength weakens, and when it is more than 2000 sec/100 cc Air, cycle characteristics can deteriorate.

The composite porous membrane of the present invention preferably has a relationship of the difference between the air resistance of the porous membrane A (X sec/100 cc Air) and the air resistance of the whole composite porous membrane (Y sec/100 cc Air)(Y−X): 10 sec/100 cc Air≦Y−X≦110 sec/100 cc Air, and more preferably, 10 sec/100 cc Air≦Y−X≦100 sec/100 cc Air. When Y−X is less than 10 sec/100 cc Air, sufficient adhesion of a heat-resistant resin layer sometimes cannot be obtained. When Y−X is more than 110 sec/100 cc Air, significant increase in air resistance is caused, and, as a result, ion permeability decreases when introduced into a battery; therefore, a separator unsuitable for a high-performance battery can be provided.

Further, the air resistance of the composite porous membrane is preferably 50 to 800 sec/100 cc Air, more preferably 100 to 500 sec/100 cc Air, and most preferably 100 to 400 sec/100 cc Air. When the value of the air resistance is lower than 50 sec/100 cc Air, sufficient insulation properties cannot be obtained, and clogging, short circuit, and membrane rupture can be caused. When the value is higher than 800 sec/100 cc Air, membrane resistance is high, and charge and discharge properties and lifetime properties in a practical range sometimes cannot be obtained.

A method of producing the composite porous membrane of the present invention will now be described.

To produce the composite porous membrane of the present invention, varnish is first applied onto a substrate film such as the polyester film or polyolefin film described above. Not by coating varnish directly to a porous membrane A, but by coating varnish once onto a substrate film and then laminating to a porous membrane A, increase in air resistance can be reduced.

Examples of the method of coating the varnish described above include the reverse roll coating method, gravure coating method, kiss coating method, roll brushing method, spray coating method, air knife coating method, wire bar bar coating method, pipe doctor method, blade coating method, die coating method, and the like, and these methods can be used alone or in combination.

The porous membrane A is then laminated to the coated surface of the substrate film described above. As a method of lamination, a method in which films from two directions are combined on a surface of one metal roll is preferred because damage to the films can be reduced. In this process, during the time from immediately after the coating to the lamination of the porous membrane A, the absolute humidity in an atmosphere needs to be maintained below 6 g/m³ (low humidity zone). When the absolute humidity is not less than 6 g/m³, a heat-resistant resin membrane can be in the state of an inhomogeneous gel or semi-gel because rapid and nonuniform moisture absorption is likely to occur. At parts where gelation proceeded, the plate resin blocks of resin described above generate when laminating the porous membrane A, leading to partial significant increase in air resistance, which is not preferred.

“Semi-gel like” herein refers to a situation where there coexist regions that have been gelled during the process of gelation of a polyamide-imide resin solution due to absorption of moisture in the atmosphere and regions that have been kept in a state of solution. In the present invention, it is preferable to laminate a porous membrane A before a heat-resistant resin membrane becomes gelled or semi-gelled. Namely, it is preferable to laminate a porous membrane A in a state of solution before gelation or semi-gelation. By maintaining the absolute humidity in an atmosphere below 6 g/m³ during the time until a porous membrane A is laminated, a homogeneous layer is formed at the interface between the porous membrane A and a porous membrane B, and the plate resin block described above will not generate.

The time from application of varnish onto a substrate film to lamination of a porous membrane A is preferably 3 seconds to 30 seconds. A heat-resistant resin membrane is leveled during this time, and a heat-resistant resin membrane with a more uniform membrane thickness is easily obtained. When the time is more than 30 seconds, a heat-resistant resin membrane is locally gelled or semi-gelled, and the uniform air resistance mentioned above sometimes cannot be obtained. The substrate film is then dipped in a coagulation bath with the porous membrane A being laminated thereto. The time from lamination of the porous membrane A until dipping in a coagulation bath is preferably 2 seconds or more. When it is less than 2 seconds, varnish sometimes cannot be filled uniformly in pores of the porous membrane A. The upper limit is not limited, and 10 seconds is enough.

In the coagulation bath, resin components and solvent components in the varnish undergo phase separation, and the resin components coagulate. The dipping time in the coagulation bath is preferably not less than 5 seconds. When it is less than 5 seconds, the phase separation and the coagulation of resin components sometimes do not proceed sufficiently. The upper limit is not limited, and 10 seconds is enough.

By injecting into a coagulation bath with such a layer constitution of porous membrane A/heat-resistant resin/substrate film, water penetrates from the porous membrane A side, and the heat-resistant resin undergoes phase separation and coagulation and converts into a porous membrane B. In this process, by covering the heat-resistant resin side with a substrate film, water gradually penetrates from the porous membrane A side and substitutes for the solvent components of the varnish; consequently, the time for the heat-resistant resin to phase-separate at the interface between the porous membrane A and the heat-resistant resin can be ensured, and a membrane having pores can be formed.

Although the thickness of the film substrate described above is not particularly limited as long as it is thick enough to maintain planarity, the thickness of 25 μm to 100 μm is suitable. When it is less than 25 μm, sufficient planarity sometimes cannot be obtained. Also, when it is more than 100 μm, planarity will not improve.

The linear oligomer amount on a substrate film surface at least at the side to which varnish is applied is preferably 20 μg/m² to 100 μg/m² and more preferably 40 μg/m² to 80 μg/m². When the linear oligomers on a film surface is less than 20 μg/m², the porous membrane B can remain on a film substrate when a composite porous membrane of the porous membrane A and the porous membrane B in a laminated state is peeled off from the substrate film. When it is more than 100 μg/m², coating spots are likely to occur during coating of the porous membrane B, and besides process contamination, for example, at a conveying roll can occur due to the linear oligomer amount on a substrate film surface.

The linear oligomer amount herein refers to the total amount of linear dimers, linear trimers, and linear tetramers derived from a polyester resin used as a raw material of a film. For example, in the case of polyester comprising, as a main repeating unit, ethylene terephthalate which is made from terephthalic acid and ethylene glycol, linear dimer means an oligomer that has two terephthalic acid units in one molecule and has a carboxylic acid terminal or a hydroxyl group terminal. Similarly, linear trimer means those which have the same terminal group as that of linear dimer except having three terephthalic acid units in one molecule, and linear tetramer means those which have the same terminal group as that of linear dimer except having four terephthalic acid units in one molecule.

In the present invention, if the linear oligomer amount of the film surface on at least one side of a polyester film is in the range described above, uniformity of the porous membrane B in application and good transcription in peeling off a composite porous membrane of the porous membrane A and the porous membrane B in a laminated state from a substrate film are simultaneously achieved. Examples of surface treatment methods for providing a linear oligomer include, but are not limited to, corona discharge treatment, glow discharge treatment, flame treatment, UV irradiation treatment, electron beam irradiation treatment, and ozone treatment. Among them, corona discharge treatment is particularly preferred because it can be carried out with relative ease.

It is also possible to perform wet film formation without peeling off the substrate film to form a porous membrane B. When this method is used, a composite porous membrane can be produced even in the case of using such a soft porous membrane A that has a low elastic modulus and shows necking due to tension during processing. Specifically, excellent properties in process workability can be expected; a composite porous membrane does not wrinkle or bend when passing through a guide roll; curling during drying can be reduced; and the like. In this case, the substrate and the composite porous membrane may be taken up simultaneously, or the substrate and the composite porous membrane may be taken up on different taking-up rolls via a drying step, but the latter taking-up method is preferred because there is little concern about winding slippage.

The composite porous membrane of the porous membrane A and the porous membrane B in a laminated state is then peeled off from the substrate film. At this time, the porous membrane B is transcribed to all over the porous membrane A, and an unwashed composite porous membrane is obtained. This is because some portions of the porous membrane B moderately remains in pores of the porous membrane A according to the solids concentration of varnish and an anchoring effect is expressed.

Further, the unwashed porous membrane described above is dipped in an aqueous solution containing a good solvent for a resin constituting the porous membrane B in an amount of 1 to 20% by weight and more preferably 5 to 15% by weight, and the washing step using pure water and the drying step using hot air at 100° C. or lower are carried out, whereby a final composite porous membrane can be obtained. According to the method described above, even when the width of the porous membrane A is not less than 100 mm, a composite porous membrane with little variation in air resistance can be obtained.

For the washing in wet film formation, common methods such as warming, ultrasonic irradiation, and bubbling can be used. Further, for keeping the concentration in each bath constant to increase washing efficiency, the method of removing the solution in a porous membrane between the baths is effective. Specific examples thereof include the method of extruding the solution in a porous layer with air or inert gas, the method of squeezing out the solution in the membrane physically with a guide roll; and the like.

Although the composite porous membrane is desirably stored in a dry state, when it is difficult to store in an absolute dry state, it is preferable to perform a vacuum drying treatment at 100° C. or less immediately before use.

The composite porous membrane can be used as a separator for batteries such as secondary batteries such as a nickel-hydrogen battery, nickel-cadmium battery, nickel-zinc battery, silver-zinc battery, lithium ion secondary battery, and lithium polymer secondary battery, and is preferably used as a separator particularly for a lithium ion secondary battery.

### EXAMPLES

A specific description will now be given by way of example, but the present invention is not limited by these Examples. The measured values in Examples were measured by the following methods.

### (1) Membrane Thickness

The membrane thickness of a porous membrane A, a porous membrane B, and a composite porous membrane was measured using a contact membrane thickness meter (M-30, digital micrometer manufactured by Sony Manufacturing Corporation). The membrane thickness of a porous membrane A was evaluated based on samples obtained by peeling off a porous membrane A from a composite porous membrane. The membrane thickness of a porous membrane B was evaluated from a difference between the membrane thickness of a composite porous membrane and the membrane thickness of a porous membrane A. For variation in membrane thickness, measurements were made at three points in total in the width direction of a separator; two points at intervals of 5 cm in cases where the width of a sample was 10 cm to 15 cm, two points at intervals of 10 cm in cases where the width was more than 15 cm, and the center in each case, and at 20 points at 5-cm intervals in the machine direction for each of the three points in the width direction. For the measured values at 60 points in total for one sample, an average thickness (t(ave)) and a difference between the maximum value and the minimum value (t(max−min)) were calculated, and a thickness variation (t(R)) was determined by the following equation. The thickness variation was assessed according to the following criteria.

Thickness variation (t(R)) (%)=t(max−min)/t(ave)×100(Criteria for Assessing Thickness Variation)

Good: The value of t(R) is less than 15%;

Fair: The value of t(R) is 15% or more and less than 30%; and

Poor: The value of t(R) is 30% or more.

### (2) Porosity

A 10-cm square sample was provided, and its sample volume (cm³) and mass (g) were measured; a porosity (%) was calculated from the results obtained using the following equation.

Porosity=(1−mass/(resin density−sample volume))×100

The sample volume (cm³) is determined by 10 cm×10 cm×thickness (cm).

### (3) Observation of Morphology of Porous Membrane, Average Pore Size, and the Number of Pores

The pore size of a porous membrane A and a porous membrane B and the average pore size of pores existing on the peeling surface on the side of the porous membrane B formed when the porous membrane A and the porous membrane B are peeled off were measured by the following method. A test piece was fixed onto a cell for measurement using double-sided tape, and platinum or gold was vacuum-deposited for several minutes. This test piece was observed using a scanning electron microscope S4800 manufactured by Hitachi High-Technologies Corporation at an accelerating voltage of 2 kV and 20,000 to 22,000 magnification. Measurements were made at arbitrary 10 points to obtain 10 SEM images. Arbitrary 50 pores were selected on (one of) the SEM image obtained, and an average value of the pore sizes of the 50 pores was employed as an average pore size of the test piece. In the case where a pore has a noncircular shape, the longest diameter was calculated as a pore size. For the pore number, an arbitrary square of 1 μm×1 μm was selected on each SEM image (10 images), and the number of pores with a pore size of 50 nm to 500 nm in the square was counted to determine the number per 10 μm². The morphology of the surface of the porous membrane B and peeling surface of the porous membrane B was assessed according to the following criteria.

### (Criteria for Assessing Morphology of Porous Membrane)

A: Three-dimensional network structure, and there does not exist a plate resin block with such a size that a circle with a diameter of 0.3 μm to 2.0 μm is included.

B: Three-dimensional network structure, there exists a plate resin block with such a size that a circle with a diameter of 0.3 μm to 2.0 μm is included.

C: Pores with a pore size of 50 nm to 500 nm exist at a rate of 100 pores/10 μm² or more.

D: Pores with a pore size of 50 nm to 500 nm is less than 100 pores/10 μm².

### (4) Air Resistance

Using a Gurley densometer type B manufactured by TESTER SANGYO CO., LTD., a composite porous membrane or a porous membrane A was fixed between a clamping plate and an adapter plate such that wrinkling did not occur, and an air resistance was measured according to JIS P-8117. For air resistance variation, measurements were made at three points in total in the width direction of a separator; two points at intervals between the centers of measuring points of 5 cm in cases where the width of a sample was 10 cm to 15 cm, two points at intervals between the centers of measuring points of 10 cm in cases where the width was more than 15 cm, and the center in each case, and at 20 points at 5 cm intervals in the machine direction for each of the three points in the width direction. For the measured values at 60 points in total for one sample, an average air resistance (T(ave)) and a difference between the maximum value and the minimum value (T(max−min)) were calculated, and an air resistance variation (T(R)) was determined by the following equation.

Air resistance variation (T(R))=T(max−min)/T(ave)×100

### (5) Inherent Viscosity

A solution obtained by dissolving 0.5 g of a heat-resistant resin in 100 ml of NMP was measured at 25° C. using an Ubbelohde viscosity tube.

### (6) Glass Transition Temperature

A resin solution or a resin solution obtained by dipping a composite porous membrane in a good solvent to dissolve only an heat-resistant resin layer was applied at an appropriate gap using an applicator to a PET film (E5001 available from TOYOBO CO., LTD.) or a polypropylene film (PYLEN-OT available from TOYOBO CO., LTD.), predried at 120° C. for 10 minutes, and then peeled. The film obtained was fixed to a metal frame of an appropriate size with a heat-resistant adhesive tape, and, in such a state, further dried under vacuum at 200° C. for 12 hours to obtain a dry film. A test piece 4 mm wide×21 mm long was cut out from the dry film obtained, and using a dynamic viscoelasticity measuring apparatus (DVA-220 manufactured by IT Keisoku Seigyo Co., Ltd.) at a measuring length of 15 mm, a storage elastic modulus (F) was measured in the range from room temperature to 450° C. under the conditions of 110 Hz and a temperature rise rate of 4° C./min. At an inflection point of the storage elastic modulus (E′) at this time, the temperature at the intersection of an extended baseline at or lower than a glass transition temperature and a tangent line showing a maximum slope at or higher than the inflection point was employed as a glass transition temperature.

### (7) Amount of Linear Oligomers on Substrate Film Surface

The surfaces to be extracted of two films were faced each other and fixed to a frame with a spacer interposed therebetween so that an area of 25.2 cm×12.4 cm per film could be extracted. Thirty ml of ethanol was injected between the extract surfaces, and linear oligomers on the film surface were extracted at 25° C. for 3 minutes. The extract was evaporated to dryness, and then dimethylformamide was added to the resulting dried residue of the extract to a volume of 200 μl. Then, using high-performance liquid chromatography, linear oligomers were quantitatively determined from a calibration curve preliminarily determined under the measurement conditions shown below. The amount of linear oligomers was defined as the sum of dimers, trimers, and tetramers, and quantitatively determined in terms of cyclic trimers.

### (Measurement Conditions)

Apparatus: ACQUITY UPLC (available from Waters)

Column: BEH-C18 2.1×150 mm (available from Waters)

Mobile phase: Eluent A: 0.1% formic acid (v/v)
Eluent B: Acetonitrile

Gradient B %: 10→98→98% (0→25→30 minutes)

Flow rate: 0.2 ml/min

Column temperature: 40° C.

Detector: UV-258 nm

### Example 1

### Synthesis of Heat-Resistant Resin

Into a four-necked flask equipped with a thermometer, a cooling tube, and a nitrogen gas introduction tube, 1 mol of trimellitic acid anhydride (TMA), 0.8 mol of o-tolidine diisocyanate (TODI), 0.2 mol of 2,4-tolylene diisocyanate (TDI), and 0.01 mol of potassium fluoride were loaded together with N-methyl-2-pyrrolidone to a solids concentration of 20% by weight and stirred at 100° C. for 5 hours, and then the resulting mixture was diluted with N-methyl-2-pyrrolidone to a solids concentration of 14% by weight to synthesize a polyamide-imide resin solution (a). The polyamide-imide resin obtained had an inherent viscosity of 1.35 dl/g and a glass transition temperature of 320° C.

The polyamide-imide resin solution (a) was diluted with N-methyl-2-pyrrolidone to prepare a varnish (a) (solids concentration: 3.5% by weight). A series of operations was carried out in dry steam at a humidity of 10% or less to prevent moisture absorption as much as possible. The moisture percentage of the varnish (a) was 0.2% by weight. The varnish (a) was applied to the surface of a polyethylene terephthalate resin (PET) film (substrate film) which has a thickness of 50 μm and a linear oligomer amount of 68 μg/m² in a surface by the blade coating method, and the substrate film was passed through a low humidity zone at a temperature of 25° C. and an absolute humidity of 1.8 g/m³ in 13 seconds to form a heat-resistant resin membrane. At 1.7 seconds after the heat-resistant resin membrane exited the low humidity zone, a porous membrane A (polyethylene porous film, width: 120 mm, thickness: 20 μm, porosity: 45%, average pore size: 0.15 μm, average air resistance: 130 sec/100 cc Air, and variation in air resistance: 2.5%) was laminated to the heat-resistant resin membrane described above, and the laminate was dipped into an aqueous solution containing N-methyl-2-pyrrolidone in an amount of 5% by weight for 10 seconds, washed with pure water, and then dried by passing through a hot-air drying furnace at 70° C., followed by peeling off from the substrate film to obtain a composite porous membrane with a final thickness of 23 μm.

### Example 2

A composite porous membrane was obtained in the same manner as in Example 1 except that the absolute humidity of the low humidity zone was 4.0 g/m³.

### Example 3

A composite porous membrane was obtained in the same manner as in Example 1 except that the absolute humidity of the low humidity zone was 5.5 g/m³.

### Example 4

A composite porous membrane was obtained in the same manner as in Example 1 except that a varnish (b), the solids concentration of varnish of which was adjusted to be 5.5% by weight, was used.

### Example 5

A composite porous membrane was obtained in the same manner as in Example 1 except that a varnish (c), the solids concentration of varnish of which was adjusted to be 2.0% by weight, was used.

### Example 6

A composite porous membrane was obtained in the same manner as in Example 1 except that the time of passage through the low humidity zone was 8.3 seconds and that the time from the exit of the low humidity zone to lamination of the porous membrane A was 1.1 seconds.

### Example 7

A composite porous membrane was obtained in the same manner as in Example 1 except that the time of passage through the low humidity zone was 26.0 seconds and that the time from the exit of the low humidity zone to lamination of the porous membrane A was 3.4 seconds.

### Example 8

A composite porous membrane was obtained in the same manner as in Example 1 except that a polyethylene porous film with a thickness of 20.0 μm, a porosity of 40%, an average pore size of 0.10 μm, an average air resistance of 450 sec/100 cc Air, and a variation in air resistance of 1.2% was used as a porous membrane A.

### Example 9

A composite porous membrane was obtained in the same manner as in Example 1 except that a polyethylene porous film with a thickness of 25.0 μm, a porosity of 45%, an average pore size of 0.15 μm, an average air resistance of 150 sec/100 cc Air, and a variation in air resistance of 3.2% was used as a porous membrane A.

### Example 10

Into a four-necked flask equipped with a thermometer, a cooling tube, and a nitrogen gas introduction tube, 1 mol of trimellitic acid anhydride (TMA), 0.80 mol of o-tolidine diisocyanate (TODI), 0.20 mol of diphenylmethane-4,4′-diisocyanate (MDI), and 0.01 mol of potassium fluoride were loaded together with N-methyl-2-pyrrolidone to a solids concentration of 20% and stirred at 100° C. for 5 hours, and then the resulting mixture was diluted with N-methyl-2-pyrrolidone to a solids concentration of 14% to synthesize a polyamide-imide resin solution (b). The polyamide-imide resin obtained had an inherent viscosity of 1.05 dl/g and a glass transition temperature of 313° C. A composite porous membrane was obtained in the same manner as in Example 1 except that a varnish (d) (solids concentration: 3.5% by weight) prepared using the polyamide-imide resin solution (b) instead of the polyamide-imide resin solution (a) was used.

### Example 11

Into a four-necked flask equipped with a thermometer, a cooling tube, and a nitrogen gas introduction tube, 1 mol of trimellitic acid anhydride (TMA), 0.60 mol of o-tolidine diisocyanate (TODI), 0.40 mol of diphenylmethane-4,4′-diisocyanate (MDI), and 0.01 mol of potassium fluoride were loaded together with N-methyl-2-pyrrolidone to a solids concentration of 20% and stirred at 100° C. for 5 hours, and then the resulting mixture was diluted with N-methyl 2-pyrrolidone to a solids concentration of 14% to synthesize a polyamide-imide resin solution (c). The polyamide-imide resin obtained had an inherent viscosity of 0.85 dl/g and a glass transition temperature of 308° C. A composite porous membrane was obtained in the same manner as in Example 1 except that a varnish (e) (solids concentration: 3.5% by weight) prepared using the polyamide-imide resin solution (c) instead of the polyamide-imide resin solution (a) was used.

### Example 12

A polyamide-imide resin solution (a), alumina particles with an average particle size of 0.5 μm, and N-methyl-2-pyrrolidone were mixed at a weight ratio of 3:1:6, and the resulting mixture was placed into a polypropylene container together with zirconium oxide beads (available from TORAY INDUSTRIES, INC., trade name: “Torayceram beads”, diameter: 0.5 mm) and dispersed for 6 hours using a paint shaker (manufactured by Toyo Seiki Seisaku-Sho, Ltd.). Then, the dispersion was filtered through a filter with a filtration limit of 5 μm and further diluted with N-methyl-2-pyrrolidone to prepare a varnish (f) (solids concentration of heat-resistant resin: 5.5% by weight). A composite porous membrane was obtained in the same manner as in Example 1 except that the varnish (f) was used instead of the varnish (a).

### Example 13

A varnish (g) (solids concentration of heat-resistant resin: 5.5% by weight) was prepared in the same manner as in Example 12 except that titanium oxide particles (available from Titan Kogyo, Ltd., trade name: “KR-380”, average particle size: 0.38 μm) was used instead of alumina particles. A composite porous membrane was obtained in the same manner as in Example 1 except that the varnish (g) was used instead of the varnish (a).

### Example 14

A composite porous membrane was obtained in the same manner as in Example 1 except that the amount of the varnish (a) applied was adjusted to a final thickness of 21.5 μm.

### Example 15

The polyamide-imide resin solution (a) obtained in Example 1 was poured into a water bath of 10 times volume of the resin solution to precipitate a resin component. Then, resin solids were washed thoroughly with water to remove NMP and then dried using a vacuum dryer under the conditions of 180° C. and 24 hours. Thereafter, the resultant was diluted with N-methyl-2-pyrrolidone to a solids concentration of 3.5% by weight to prepare a varnish (h). The moisture percentage of the varnish (h) was 0.05% by weight. A composite porous membrane was obtained in the same manner as in Example 1 except that the varnish (h) was used instead of the varnish (a).

### Example 16

A composite porous membrane was obtained in the same manner as in Example 1 except that polyethylene porous membrane with a width of 300 mm, a thickness of 20 μm, a porosity of 45%, an average pore size of 0.15 μm, an average air resistance of 130 sec/100 cc Air, and a variation in air resistance of 2.0% was used as a porous membrane A.

### Example 17

A composite porous membrane was obtained in the same manner as in Example 1 except that a porous membrane (thickness: 25 μm, porosity: 40%, average pore size: 0.10 μm, average air resistance: 620 sec/100 cc Air, and variation in air resistance: 1.6%) having a three-layer structure of polypropylene/polyethylene/polypropylene (thickness ratio: 8/9/8) was used as a porous membrane A.

### Example 18

Twenty-five parts by mass of the polyamide-imide resin solution (a) used in Example 1 was diluted with 72 parts by mass of N-methyl-2-pyrrolidone, and 3 parts by mass of ethylene glycol was further added as a phase separation aid to prepare a varnish (i) (solids concentration: 3.5% by weight). A composite porous membrane was obtained in the same manner as in Example 1 except that the varnish (i) was used instead of the varnish (a).

### Example 19

Twenty-five parts by mass of the polyamide-imide resin solution (a) used in Example 1 was diluted with 62 parts by mass of N-methyl-2-pyrrolidone, and 13 parts by mass of ethylene glycol was further added as a phase separation aid to prepare a varnish (j) (solids concentration: 3.5% by weight). A composite porous membrane was obtained in the same manner as in Example 1 except that the varnish (j) was used instead of the varnish (a).

### Example 20

A composite porous membrane was obtained in the same manner as in Example 1 except that a varnish (1), the solids concentration of varnish of which was adjusted to be 12.0% by weight, was used.

### Comparative Example 1

Thirty-nine parts by mass of the polyamide-imide resin solution (a) used in Example 1 was diluted with 48 parts by mass of N-methyl-2-pyrrolidone, and 13 parts by mass of ethylene glycol was further added as a phase separation aid to prepare a varnish (k) (solids concentration: 5.5% by weight). A composite porous membrane was obtained in the same manner as in Example 1 except that the varnish (k) was used instead of the varnish (a) and the low humidity zone was set at a temperature of 25° C. and an absolute humidity of 18.5 g/m³.

### Comparative Example 2

A composite porous membrane was obtained in the same manner as in Example 1 except that the low humidity zone was set at a temperature of 25° C. and an absolute humidity of 18.8 g/m³.

### Comparative Example 3

The porous membrane A used in Example 1 was coated with the varnish (a) by the blade coating method, passed through the low humidity zone at a temperature of 25° C. and an absolute humidity of 1.8 g/m³ in 13 seconds, and then, after 2 seconds, dipped into an aqueous solution containing N-methyl-2-pyrrolidone in an amount of 5% by weight for 10 seconds. Thereafter, the resultant was washed with pure water and then dried by passing through a hot-air drying furnace at 70° C. to obtain a composite porous membrane with a final thickness of 23.0 μm.

### Comparative Example 4

A composite porous membrane was obtained in the same manner as in Comparative Example 3 except that the porous membrane A used in Example 1 was used with its pores filled with N-methyl-2-pyrrolidone by dipping in N-methyl-2-pyrrolidone in advance.

### Comparative Example 5

A composite porous membrane was obtained in the same manner as in Comparative Example 1 except that the porous membrane A was changed to the porous membrane A used in Example 16.

### Comparative Example 6

Production of a composite porous membrane was attempted in the same manner as in Example 1 except that a polyethylene terephthalate resin film which has a linear oligomer amount of 3 μg/m² in a surface was used as a substrate film instead of the polyethylene terephthalate resin film which has a linear oligomer amount of 68 μg/m² in a surface. However, when a composite porous membrane of a porous membrane A and a porous membrane B in a laminated state was peeled off from the substrate film, the porous membrane B remained on the film substrate, and a composite porous membrane could not be obtained.

### Comparative Example 7

Production of a composite porous membrane was attempted in the same manner as in Example 1 except that a polyethylene terephthalate resin film which has a linear oligomer amount of 120 μg/m² in a surface was used as a substrate film instead of the polyethylene terephthalate resin film which has a linear oligomer amount of 68 μg/m² in a surface. However, a composite porous membrane of a porous membrane A and a porous membrane B in a laminated state was peeled off from the substrate film in a coagulation bath (in an aqueous solution containing 5% by weight of N-methyl-2-pyrrolidone); consequently, normal planarity could not be obtained, and conveyance and taking-up could not be carried out.

Conditions for producing a composite porous membrane in Examples 1 to 20 and Comparative Examples 1 to 7 and properties of a porous membrane A and a composite porous membrane are shown in Table 1.

TABLE 1

| | | | | | | | Composite porous membrane | | | | | | |
|---|---|---|---|---|---|---|---|---|---|---|---|---|---|
| | | | | | | | | | | Peeling | | Rising | |
| | Porous membrane A | | | | Low humidity zone | | | Thickness | Surface | surface | Average | range of | |
| | | Air re- | Po- | | | Time | Average | variation | morphology | morphology | air re- | air re- | Air re- |
| | Thick- | sistance | ros- | | Absolute | of | thick- | in porous | of porous | of porous | sistance | sistance | sistance |
| | ness | (sec/100 | ity | Var- | humidity | passage | ness | membrane | membrane | membrane | (sec/100 | (sec/100 | variation |
| | (μm) | ccAir) | (%) | nish | (g/m3) | (sec) | (μm) | B (%) | B | B | ccAir) | ccAir) | (%) |
| Example 1 | 20.0 | 130 | 45 | a | 1.8 | 13.0 | 23.0 | good | A | C | 160 | 30 | 8 |
| Example 2 | 20.0 | 130 | 45 | a | 4.0 | 13.0 | 23.0 | good | A | C | 153 | 23 | 13 |
| Example 3 | 20.0 | 130 | 45 | a | 5.5 | 13.0 | 23.0 | good | A | C | 145 | 15 | 20 |
| Example 4 | 20.0 | 130 | 45 | b | 1.8 | 13.0 | 23.0 | good | A | C | 170 | 40 | 9 |
| Example 5 | 20.0 | 130 | 45 | c | 1.8 | 13.0 | 23.0 | good | A | C | 145 | 15 | 8 |
| Example 6 | 20.0 | 130 | 45 | a | 1.8 | 8.3 | 23.0 | good | A | C | 161 | 31 | 11 |
| Example 7 | 20.0 | 130 | 45 | a | 1.8 | 26.0 | 23.0 | good | A | C | 157 | 27 | 7 |
| Example 8 | 20.0 | 450 | 40 | a | 1.8 | 13.0 | 23.0 | good | A | C | 495 | 45 | 8 |
| Example 9 | 25.0 | 130 | 45 | a | 1.8 | 13.0 | 28.0 | good | A | C | 205 | 55 | 12 |
| Example 10 | 20.0 | 130 | 45 | d | 1.8 | 13.0 | 23.0 | good | A | C | 158 | 28 | 8 |
| Example 11 | 20.0 | 130 | 45 | e | 1.8 | 13.0 | 23.0 | good | A | C | 157 | 27 | 8 |
| Example 12 | 20.0 | 130 | 45 | f | 1.8 | 13.0 | 23.0 | good | A | C | 165 | 35 | 9 |
| Example 13 | 20.0 | 130 | 45 | g | 1.8 | 13.0 | 23.0 | good | A | C | 175 | 45 | 10 |
| Example 14 | 20.0 | 130 | 45 | a | 1.8 | 13.0 | 21.5 | good | A | C | 210 | 80 | 15 |
| Example 15 | 20.0 | 130 | 45 | h | 1.8 | 13.0 | 23.0 | good | A | C | 158 | 28 | 5 |
| Example 16 | 20.0 | 130 | 45 | a | 1.8 | 13.0 | 23.0 | fair | A | C | 160 | 30 | 10 |
| Example 17 | 25.0 | 620 | 40 | a | 1.8 | 13.0 | 28.0 | fair | A | C | 680 | 60 | 3 |
| Example 18 | 20.0 | 130 | 45 | i | 1.8 | 13.0 | 23.0 | good | A | C | 154 | 24 | 16 |
| Example 19 | 20.0 | 130 | 45 | j | 1.8 | 13.0 | 23.0 | good | A | C | 158 | 28 | 25 |
| Example 20 | 20.0 | 130 | 45 | l | 1.8 | 13.0 | 23.0 | good | A | C | 235 | 105 | 11 |
| Compar- | 20.0 | 130 | 45 | k | 18.5 | 13.0 | 23.0 | good | A | B | 270 | 140 | 70 |
| ative | | | | | | | | | | | | | |
| Example 1 | | | | | | | | | | | | | |
| Compar- | 20.0 | 130 | 45 | a | 18.8 | 13.0 | 23.0 | good | A | B | 240 | 110 | 55 |
| ative | | | | | | | | | | | | | |
| Example 2 | | | | | | | | | | | | | |
| Compar- | 20.0 | 130 | 45 | a | 1.8 | 13.0 | 23.0 | poor | A | D | 769 | 639 | 60 |
| ative | | | | | | | | | | | | | |
| Example 3 | | | | | | | | | | | | | |
| Compar- | 20.0 | 130 | 45 | a | 1.8 | 13.0 | 23.0 | good | A | A | 135 | 5 | 8 |
| ative | | | | | | | | | | | | | |
| Example 4 | | | | | | | | | | | | | |
| Compar- | 20.0 | 130 | 45 | k | 18.5 | 13.0 | 23.0 | fair | A | B | 295 | 165 | 85 |
| ative | | | | | | | | | | | | | |
| Example 5 | | | | | | | | | | | | | |
| Compar- | 20.0 | 130 | 45 | a | 1.8 | 13.0 | 23.0 | — | — | — | — | — | — |
| ative | | | | | | | | | | | | | |
| Example 6 | | | | | | | | | | | | | |
| Compar- | 20.0 | 130 | 45 | a | 1.8 | 13.0 | 23.0 | — | — | — | — | — | — |
| ative | | | | | | | | | | | | | |
| Example 7 | | | | | | | | | | | | | |

### INDUSTRIAL APPLICABILITY

The composite porous membrane of the present invention provides one that shows very little variation in air resistance even if lithium ion secondary batteries increasingly become larger in size in the future and relatively wide one is demanded in industrial circles.

1. A composite porous membrane used as a separator for a battery, comprising a porous membrane A made of a polyolefin resin and a porous membrane B containing a heat-resistant resin laminated thereto, wherein a surface of the porous membrane B on a side that does not face the porous membrane A has a three-dimensional network structure having nodes, and a peeling interface on a side of the porous membrane B formed when the porous membrane A and the porous membrane B are peeled off has a membrane morphology having pores with a pore size of 50 to 500 nm in an amount of at least 100 pores/10 μm².

2. The composite porous membrane according to claim 1, which satisfies:
10≦Y−X≦110
wherein, X is air resistance (sec/100 cc Air) of the porous membrane A, and Y is air resistance (sec/100 cc Air) of the whole composite porous membrane.

3. The composite porous membrane according to claim 1, wherein the composite having a width of 100 mm or more.

4. The composite porous membrane according to claim 1, having an air resistance of 50 to 800 sec/100 cc Air.

5. The composite porous membrane according to claim 1, wherein the heat-resistant resin is a polyamide-imide resin, polyimide resin, or polyamide resin.

6. A method of producing the composite porous membrane according to claim 1, comprising:
A step (i) of coating a heat-resistant resin solution having a solids concentration of the heat-resistant resin of 1% by weight to 6% by weight onto a substrate film, and then passing the substrate film through a low humidity zone at an absolute humidity of less than 6 g/m³ to form a heat-resistant resin membrane on the substrate film; and
A step (ii) of laminating the heat-resistant resin membrane formed in step (i) and the porous membrane A made of a polyolefin resin, and then converting the heat-resistant resin membrane into a porous membrane B by dipping in a coagulation bath, followed by washing and drying, thereby obtaining a composite porous membrane.

7. The method according to claim 6, wherein the substrate film is peeled off after obtaining a composite porous membrane in step (ii).

8. The method according to claim 6, wherein the substrate film is a polyester film or polyolefin film with a thickness of 25 to 100 μm.

9. The method according to claim 6, wherein, in step (i), time of passage through the low humidity zone is 3 seconds to 30 seconds.

10. The composite porous membrane according to claim 2, having a width of 100 mm or more.

11. The composite porous membrane according to claim 2, having an air resistance of 50 to 800 sec/100 cc Air.

12. The composite porous membrane according to claim 3, having an air resistance of 50 to 800 sec/100 cc Air.

13. The composite porous membrane according to claim 2, wherein the heat-resistant resin is a polyamide-imide resin, polyimide resin, or polyamide resin.

14. The composite porous membrane according to claim 3, wherein the heat-resistant resin is a polyamide-imide resin, polyimide resin, or polyamide resin.

15. The composite porous membrane according to claim 4, wherein the heat-resistant resin is a polyamide-imide resin, polyimide resin, or polyamide resin.

16. The method according to claim 7, wherein the substrate film is a polyester film or polyolefin film with a thickness of 25 to 100 μM.

17. The method according to claim 7, wherein, in step (i), time of passage through the low humidity zone is 3 seconds to 30 seconds.

18. The method according to claim 8, wherein, in step (i), time of passage through the low humidity zone is 3 seconds to 30 seconds.
